(19) United States
(12) Patent Application Publication
(10) Pub. No.: US 2020/0220729 A1
(43) Pub. Date: Jul. 9, 2020

(54) SYSTEM AND METHOD FOR AUTHENTICATING A SENDER OF AN ELECTRONIC MAIL (E-MAIL) OVER A NETWORK

(71) Applicant: HCL AMERICA, INC., Sunnyvale, CA (US)

(72) Inventors: MICHAEL JAMES HUDSON, BOCA RATON, FL (US); JOHN WILLIAM BARRS, II, BOCA RATON, FL (US)

(21) Appl. No.: 16/243,839

(22) Filed: Jan. 9, 2019

(51) Int. Cl. H04L 9/32; H04L 9/06; H04L 9/30; H04L 9/14; H04L 29/06; H04L 12/58

(52) U.S. Cl. CPC H04L 9/3247; H04L 9/0637; H04L 9/30; H04L 2209/38; H04L 63/126; H04L 51/22; H04L 51/12; H04L 9/14

(57) ABSTRACT

Disclosed is a system for authenticating a sender of an E-mail to be sent over a network. The system assigns a public key and a private key to each of a plurality of E-mail addresses and thereby stores a plurality of public key over a blockchain. The system further sends an E-mail to a recipient over a network by creating a header, in the E-mail, storing content that needs to be sent to a recipient. The system further analyzes the header to determine whether the E-mail address is present on the blockchain. If the E-mail address is present, the system further retrieves a public key, of the plurality of public keys, corresponding to the E-mail address from the blockchain. The system further authenticates the sender of the E-mail upon verifying the signature, used to sign the content, by using the public key retrieved for the E-mail address from the blockchain.

### CROSS REFERENCE TO RELATED APPLICATIONS

This patent application does not claim priority from any application.

### TECHNICAL FIELD

The present subject matter described herein, in general, relates to a method and system for authenticating a sender of an Electronic mail (E-mail) over a network.

### BACKGROUND

Electronic mail (E-mail) is prone to phishing, spam and other fraudulent and/or annoying attacks due to fundamental limitations and vulnerabilities in its underlying protocol i.e. Simple Mail Transport Protocol (SMTP). Anyone with access to an SMTP server can send the E-mail to any other address and fake out sender's address. This is an effective way to make a recipient believe that the E-mail came from another sender. In its most dangerous form, this attack may fool the recipient into opening a malicious message and trusting its fraudulent content, including links to malicious web sites which appear to be legitimate.

In its most basic form, SMTP splits the content into data into three areas i.e. Command, Header, and Body. In Command, MAIL FROM command is used to identify the sender. The SMTP server may restrict sending mail to known, and in some cases authenticated, senders. In Header, SMTP messages may have any number of headers. Some, such as ‘From’ and ‘Subject’ are well known, and may be treated as mandatory by some mail clients and servers. In Body, the content of the message, which may be plain text, Hypertext Markup Language (HTML), Multipurpose Internet Mail Extensions (MIME) or a mixture thereof.

In the simplest case, spoofing the sender is as trivial as connecting to an unprotected SMTP server. This may be done by spoofing ‘MAIL FROM’ command and/or ‘From’ header. This is a known, and extremely common problem and there are plenty of attempted solutions in use today with varying degrees of success. One such solution is provided in U.S. Pat. No. 6,986,049 referred as Domain Keys Identified Mail (DKIM). DKIM includes a digital signature of the sending server's domain (that may be verified against the global DNS records). It may be noted that DKIM verifies the signature which proves that the E-mail is originated from a server which matches the senders declared domain. However, DKIM fails to verify legitimacy of the sender. In addition to the above, DKIM is wholly ineffective in identifying legitimate senders from a public or shared domain (including but not limited to Gmail™, Hotmail™, Yahoo Mail™, Rediffmail™, and AOL™). This means that while DKIM is an effective mechanism for large businesses to establish trust, many small businesses, and personal users, are left with no way to verify their authenticity.

### SUMMARY

Before the present systems and methods are described, it is to be understood that this application is not limited to the particular systems and methodologies described as there can be multiple possible embodiments which are not expressly illustrated in the present disclosure. It is also to be understood that the terminology used in the description is for the purpose of describing the particular versions or embodiments only and is not intended to limit the scope of the present application. This summary is provided to introduce concepts related to systems and methods for authenticating a sender of an Electronic mail (E-mail) over a network and the concepts are further described below in the detailed description. This summary is not intended to identify essential features of the claimed subject matter nor is it intended for use in limiting the scope of the claimed subject matter.

In one implementation, a system for authenticating a sender of an Electronic mail (E-mail) over a network is disclosed. The system may comprise a processor and a memory coupled to the processor. The processor may execute a plurality of modules present in the memory. The plurality of modules may comprise a key assigning module, a sender's E-mail service provider module, a recipient's E-mail service provider module, and an authentication module. The key assigning module may assign a public key and a private key to each of a plurality of E-mail addresses. In one aspect, the public key and the private key may be assigned upon registration of an E-mail address with an E-mail service provider of a. plurality of E-mail service providers. The key assigning module may further store a plurality of public keys, associated to the plurality of E-mail addresses, over a blockchain associated to the plurality of E-mail service providers. The sender's E-mail service provider module may send an E-mail to a recipient over a network by creating a header, in the E-mail, storing content that needs to be sent to a recipient over a network. It may be noted that the content stored in the header may be signed by using a private key associated to the E-mail address belonging to the sender. The recipient's E-mail service provider module may further analyze the header to determine whether the E-mail address is present on the blockchain. The recipient's E-mail service provider module may further retrieve a public key, of the plurality of public keys, corresponding to the E-mail address from the blockchain, when the E-mail address is present on the blockchain. The authentication module may authenticate the sender of the E-mail upon verifying the signature, used to sign the content, by using the public key retrieved for the E-mail address from the blockchain.

In another implementation, a method for authenticating a sender of an Electronic mail (E-mail) over a network is disclosed. In order to authenticate the sender, initially, a public key and a private key may be assigned to each of a plurality of E-mail addresses. In one aspect, the public key and the private key may be assigned upon registration of an E-mail address with an E-mail service provider of a plurality of E-mail service providers. Upon assignment of the public key and the private key, a plurality of public keys, associated to the plurality of E-mail addresses, may be stored over a blockchain associated to the plurality of E-mail service providers. Subsequent to the storing of the plurality of public keys, an E-mail may be sent, by an E-mail service provider of a sender, to a recipient over a network by creating a header, in the E-mail. storing content that needs to be sent to the recipient. It may be noted that the content stored in the header may be signed by using a private key associated to the E-mail address belonging to the sender. Post sending the E-mail, the header may be analyzed, by an E-mail service provider of the recipient, to determine whether the E-mail address is present on the blockchain. Further a public key, of the plurality of public keys, corresponding to the E-mail address may be retrieved from the blockchain, when the E-mail address is present on the blockchain. Once the public key is identified, the sender of the E-mail may be authenticated upon verifying the signature, used to sign the content, by using the public key retrieved for the E-mail address from the blockchain. In one aspect, the aforementioned method for authenticating the sender may be performed by a processor using programmed instructions stored in a memory of a system.

In one implementation, a non-transitory computer readable medium embodying a program executable in a computing device for authenticating a sender of an Electronic mail (E-mail) over a network is disclosed. The program may comprise a program code for assigning a public key and a private key to each of a plurality of E-mail addresses, wherein the public key and the private key are assigned upon registration of an E-mail address with an E-mail service provider of a plurality of E-mail service providers. The program may further comprise a program code for storing a plurality of public keys, associated to the plurality of E-mail addresses, over a blockchain associated to the plurality of E-mail service providers. The program may further comprise a program code for sending, by an E-mail service provider of a sender, an E-mail to a recipient over a network by creating a header, in the E-mail, storing content that needs to be sent to the recipient, wherein the content stored in the header is signed by using a private key associated to the E-mail address belonging to the sender. The program may further comprise a program code for analyzing, by an E-mail service provider of the recipient, the header to determine whether the E-mail address is present on the blockchain. The program may further comprise a program code for retrieving, by the E-mail service provider of the recipient, a public key, of the plurality of public keys, corresponding to the E-mail address from the blockchain, when the E-mail address is present on the blockchain. The program may further comprise a program code for authenticating the sender of the E-mail upon verifying the signature, used to sign the content, by using the public key retrieved for the E-mail address from the blockchain.

### BRIEF DESCRIPTION OF THE DRAWINGS

The foregoing detailed description of embodiments is better understood when read in conjunction with the appended drawings. For the purpose of illustrating the disclosure, example constructions of the disclosure are shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for authenticating a sender of an Electronic mail (E-mail) over a network, in accordance with an embodiment of the present subject matter.

FIG. 2 illustrates the system, in accordance with an embodiment of the present subject matter.

FIG. 3 illustrates a method for authenticating the sender of the E-mail, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The proposed invention facilitates to authenticate a sender of an Electronic mail (E-mail) to be sent over a network is disclosed. The proposed invention expands on various known art and adds an additional verification layer that relies on a registry of known senders shared between participating mail service providers by using a distributed ledger technology. Examples of the participating mail service providers may include, but not limited to, Gmail™, Hotmail™, Yahoo Mail™, Rediffmail™, and AOL™.

It may be noted that users of the participating mail service may choose to store their identity on a blockchain. As and when, a user wishes to be registered with a participating mail service provider, a pair of Public-Private key may be assigned to an Email address opted by the user during the registration process. The identity of the user may be stored in the form of an Email address and a Public key. This may be done as part of onboarding or profile management and it results in a private key, of the pair of Public-Private key, being allocated to the Email address. It may be noted that the private key may be maintained by either the participating mail service provider or the user himself/herself (enabled by a feature in her mail client software), or some third party custodian. In other words, a combination of the Email address and the Public key is stored on a blockchain distributed ledger shared between the participating mail service provider who have subscribed to the service.

Upon registration and assignment of the pair of Public-Private key, if a sender wishes to create an email that needs to be sent to a recipient, the body of the email is signed with the private key which may then be put into a header. The email, including the content signed with the private key, may then be transmitted by an E-mail service provider of the sender to an E-mail service provider of the recipient. When the E-mail service provider of the recipient receives the email, the blockchain record is looked up for the email address, associated to the user who sends the email, to determine whether the email address is present on the blockchain. If the email address is present on the blockchain, the content, signed with the private key, is verified by using the public key in order to authenticate the signature. In other words, the public key is retrieved to verify the Initial_Validator_Signature by standard cryptographic means. Thus, in this manner, the sender of the E-mail may be authenticated over a network

While aspects of described system and method for authenticating the sender of the E-mail over the network may be implemented in any number of different computing systems, environments, and/or configurations, the embodiments are described in the context of the following exemplary system.

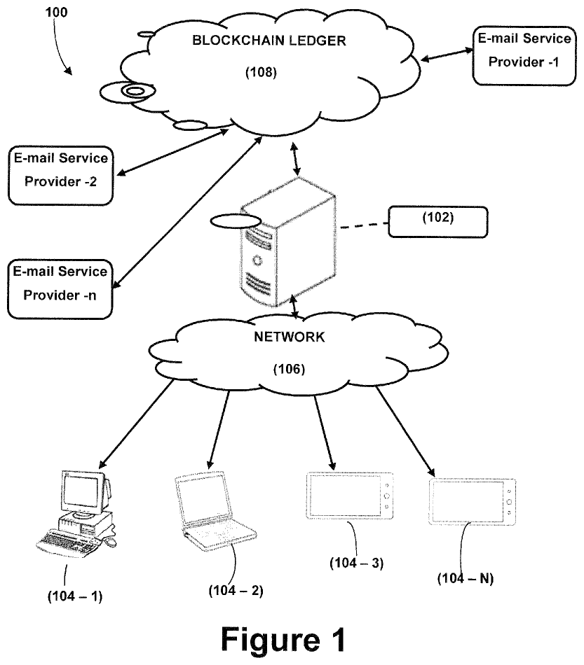

Referring now to FIG. 1, a network implementation 100 of a system 102 for authenticating a sender of an Electronic mail (E-mail) over a network is disclosed. In order to authenticate the sender, initially, the system 102 assigns a public key and a private key to each of a plurality of E-mail addresses. In one aspect, the public key and the private key may be assigned upon registration of an E-mail address with an E-mail service provider of a plurality of E-mail service providers i.e. E-mail service provider 1, E-mail service provider 2, . . . , E-mail service provider N. Upon assignment of the public key and the private key, the system 102 stores a plurality of public keys, associated to the plurality of E-mail addresses, over a blockchain 108 associated to the plurality of E-mail service providers. Subsequent to the storing of the plurality of public keys over the blockchain 108, the system 102 enabling an E-mail service provider of a sender to send an E-mail to a recipient over a network by creating a header, in the E-mail, storing content that needs to be sent to the recipient. It may be noted that the content stored in the header may be signed by using a private key associated to the E-mail address belonging to the sender. Post sending the E-mail, the system 102 enables an E-mail service provider of the recipient to analyze the header in order to determine whether the E-mail address is present on the blockchain 108. Further the system 102 retrieves a public key, of the plurality of public keys, corresponding to the E-mail address from the blockchain 108, when the E-mail address is found to be present on the blockchain 108. Once the public key is identified, the system 102 authenticates the sender of the E-mail upon verifying the signature, used to sign the content, by using the public key retrieved for the E-mail address from the blockchain 108.

It may be understood that the system 102 may be implemented in a variety of computing systems, such as a laptop computer, a desktop computer, a notebook, a workstation, a mainframe computer, a server, a network server, a cloud-based computing environment. It will be understood that the system 102 may be communicatively coupled with the plurality of E-mail service providers i.e. E-mail service provider 1, E-mail service provider 2, . . . , E-mail service provider N. Examples of the plurality of E-mail service providers may include, but not limited to, Gmail™, Hotmail™, Yahoo Mail™, Rediffmail™, and AOL™. Further the system 102 may be accessed by multiple users through one or more client machines 104-1, 104-2 . . . 104-N, collectively referred to as user 104 or stakeholders, hereinafter, or applications residing on the client machine 104. In one implementation, the system 102 may comprise the cloud-based computing environment in which a user may operate individual computing systems configured to execute remotely located applications. Examples of the client machines 104 may include, but are not limited to, a portable computer, a personal digital assistant, a handheld device, and a workstation. The client machine 104 is communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Hypertext Transfer Protocol Secure (HTTPS), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

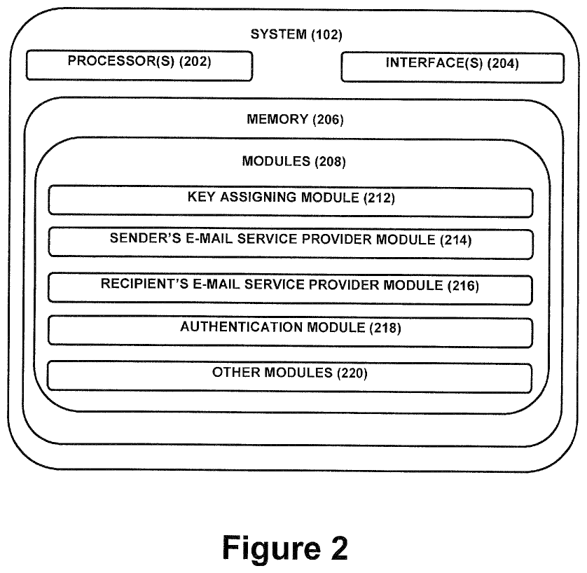

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208.

The modules 208 include routines, programs, objects, components, data structures, etc., which perform particular tasks or implement particular abstract data types. In one implementation, the modules 208 may include a key assigning module 212, a sender's E-mail service provider module 214, a recipient's E-mail service provider module 216, and an authentication module 218, and other modules 220. The other modules 220 may include programs or coded instructions that supplement applications and functions of the system 102. The modules 208 described herein may be implemented as software modules that may be executed in the cloud-based computing environment of the system 102.

As there are various challenges observed in the existing art, the challenges necessitate the need to build the system 102 for authenticating a sender of an Electronic mail (E-mail) over a network. In order to authenticate the sender, at first, a user may use the client machine 104 to access the system 102 via the I/O interface 204. The user may register them using the I/O interface 204 to use the system 102. In one aspect, the user may access the I/O interface 204 of the system 102. The system 102 may employ the key assigning module 212, the sender's E-mail service provider module 214, the recipient's E-mail service provider module 216, and the authentication module 218. The detail functioning of the modules is described below.

The key assigning module 212 assigns a public key and a private key to each of a plurality of E-mail addresses. In one aspect, the public key and the private key are assigned upon registration of an E-mail address with an E-mail service provider of a plurality of E-mail service providers. Examples of the participating E-mail service providers may include, but not limited to, Gmail™, Hotmail™, Yahoo Mail™, Rediffmail™, and AOL™. Subsequent to the assignment of the plurality of public keys, the key assigning module 212 stores a plurality of public keys, associated to the plurality of E-mail addresses, over a blockchain 108. In one aspect, the blockchain 108 is associated to the plurality of E-mail service providers which indicates that the participants in the blockchain 108 are all participating mail service providers.

In order to elucidate the functioning of the key assigning module 212, consider an example where the key assigning module 212 assigns a public key and a private key to a set of email addresses registered with at least one E-mail service provider. Such as the key assigning module 212 assigns a public key ‘PU₁’ and ‘PR₁’ to E-mail “abc . . . @gmail.com” belonging to User U₁. It may be noted that the E-mail service provider of User U₁ is ‘Gmail™’. Similarly, the key assigning module 212 assigns ‘PU₂’ and ‘PR₂’ to E-mail ‘abc . . . @yahoomail.com’ belonging to User U₂. It may be noted that the E-mail service provider of User U₂ is ‘Yahoomail™’. Subsequently, the key assigning module 212 stores association of ‘PU₁’ with “abc . . . @gmail.com” and ‘PU₂’ with “abc . . . @yahoomail.com” over the blockchain 108.

After storing the plurality of public keys over the blockchain 108, the sender's E-mail service provider module 214 sends an E-mail to a recipient over the network by using Simple Mail Transfer Protocol (SMTP). In one aspect, the E-mail, sent to the recipient, comprises a header in the E-mail, wherein the header storing content which needs to be sent to the recipient. In one aspect, the content stored in the header may be signed by using a private key associated to the E-mail address belonging to the sender. The signing of content, in the header, indicates that the content is encrypted or hashed by using the private key associated to the E-mail address belonging to the sender. After sending the E-mail to the recipient, the recipient's E-mail service provider module 216 enables an E-mail service provider of the recipient to analyze the header in order to determine whether the E-mail address is present over the blockchain 108. The recipient's E-mail service provider module 216 may then enable the recipient's E-mail service provider to look for the E-mail address, belonging to the sender, over the blockchain 108.

Referring to the same example as aforementioned, considering that U₁ sends an E-mail to U₂. In order to send the E-mail, U₁ creates a header, storing the content, in the body of the E-mail. The content is then signed or encrypted by the private key assigned to the E-mail address (“abc . . . @gmail.com”) belonging to U₁ i.e. (‘PR₁’). The E-mail including the header with signed content is then sent to the E-mail address (i.e. “abc . . . @yahoomail.com”) belonging to U₂ over the network. When the E-mail service provider of the recipient (i.e. Yahoo mail) receives the E-mail, it analyzes the header and look for the presence of the sender's E-mail address (i.e. “abc . . . @gmail.com”) over the blockchain 108.

If it is determined that the E-mail address is present over the blockchain 108, the recipient's E-mail service provider module 216 retrieves a public key, of the plurality of public keys, corresponding to the E-mail address from the blockchain 108. Subsequently, the authentication module 218 authenticates the sender of the E-mail upon verifying the signature, used to sign the content, by using the public key retrieved for the E-mail address from the blockchain 108. In one aspect, the authentication module 218 marks the E-mail as verified when the sender of the E-mail is authenticated. In one example, if the sender is authenticated, the E-mail is indicated with a Green Mark. In another aspect, the E-mail is marked as fraudulent, when the E-mail address of the sender is found over the blockchain 108. However, the public key, associated to the E-mail address, cannot be used to authenticate the E-mail address. In such a scenario, the E-mail received from the sender's E-mail address is indicated with a Red Mark. Further, if the E-mail address of the sender is not found over the blockchain 108, the authenticity of the E-mail cannot be determined and the E-mail is delivered as unmarked.

It may be noted that marking of the E-mail with Green or Red color is illustrated as an embodiment of the aforementioned application. The authenticity of the E-mail may also be indicated with other indicators as well. For example, if the sender is authenticated, the E-mail may be indicated with words such as “E-mail address authenticated”. Similarly, if the sender is not authenticated, the E-mail may be indicated with words such as “E-mail address not authenticated”. In another example, the authenticity of the E-mail may further be marked with various icons of distinct shapes.

In order to elucidate the functioning of the recipient's E-mail service provider module 216 and the authentication module 218, continuing with the same example as aforementioned. If the presence of the sender's E-mail address (i.e. “abc . . . @gmail.com”) is found over the blockchain 108, the recipient's E-mail service provider module 216 retrieves ‘PU₁’, as the public key associated to the “abc . . . @gmail.com”, from the blockchain 108. Thereafter the authentication module 218 verifies the signature, used to sign the content, by using ‘PU₁’ to authenticate U₁ as the sender of the E-mail to be sent over the network. If the sender is authenticated, the E-mail is marked with a Green Mark.

On the other hand, if the E-mail address (i.e. “abc . . . @gmail.com”) is found over the blockchain 108 and the public key i.e. ‘PU₁’, associated to “abc . . . @gmail.com”, cannot be used to authenticate the E-mail address, then the E-mail is marked as fraudulent and is indicated with a Red Mark. Further, if the E-mail address “abc . . . @gmail.com” is not found over the blockchain 108, the authenticity of the E-mail cannot be determined and the E-mail is delivered as unmarked. Thus, in this manner, the system 102 authenticates the sender of the E-mail to be sent over the network.

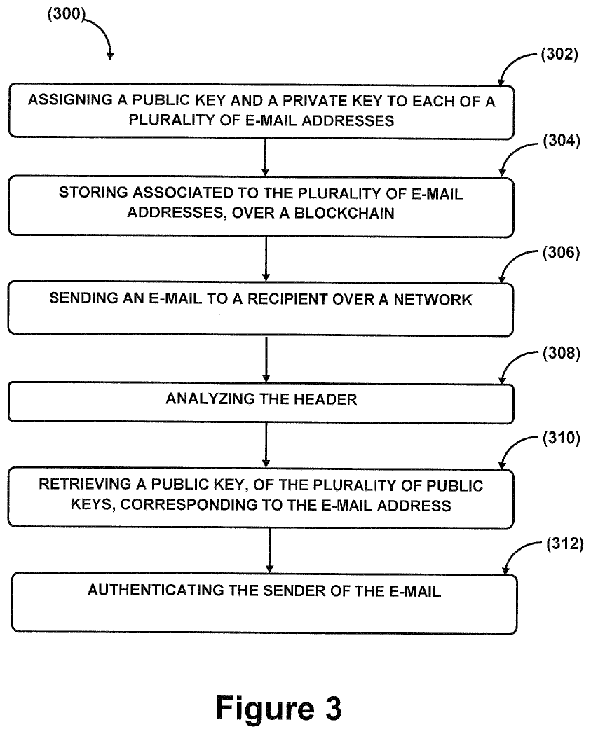

Referring now to FIG. 3, a method 300 for authenticating a sender of an Electronic mail (E-mail) over a network is shown, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented as described in the system 102.

At block 302, a public key and a private key may be assigned to each of a plurality of E-mail addresses. In one aspect, the public key and the private key may be assigned upon registration of an E-mail address with an E-mail service provider of plurality of E-mail service providers. In one implementation, the public key and the private key may be assigned by the key assigning module 212.

At block 304, a plurality of public keys, associated to the plurality of E-mail addresses, may be stored over a blockchain 108 associated to the plurality of E-mail service providers. In one implementation, the plurality of public keys may be stored over the blockchain 108 by the key assigning module 212.

At block 306, an E-mail may be sent to a recipient over a network by creating a header, in the E-mail, storing content that needs to be sent to the recipient. In one aspect, the content stored in the header may be signed by using a private key associated to the E-mail address belonging to the sender. In one implementation, the E-mail may be sent by the sender's E-mail service provider module 214.

At block 308, the header may be analyzed, by an E-mail service provider of the recipient, to determine whether the E-mail address is present over the blockchain 108. In one implementation, the recipient's E-mail service provider module 216 enables the E-mail service provider of the recipient to analyze the header.

At block 310, a public key, of the plurality of public keys, corresponding to the E-mail address may be retrieved from the blockchain 108 when the E-mail address is present on the blockchain 108. In one implementation, the public key may be retrieved by the recipient's E-mail service provider module 216.

At block 312, the sender of the E-mail may be authenticated upon verifying the signature, used to sign the content, by using the public key retrieved for the E-mail address from the blockchain 108. In one aspect, the E-mail is marked as verified and indicated with a Green Mark, when the E-mail address of the sender is authenticated. On the other hand, the E-mail is marked as fraudulent and indicated with a Red Mark, when the E-mail address of the sender is found over the blockchain 108 and the public key, associated to the E-mail address, cannot be used to authenticate the sender. Further, if the E-mail address is not found over the blockchain 108, then the E-mail is neither determined as authenticated nor fraudulent. In such a scenario, where the E-mail is neither determined as authenticated nor fraudulent, the E-mail is delivered as unmarked.

In one implementation, the authentication of the E-mail sent by the sender is performed by the authentication module 218.

Exemplary embodiments discussed above may provide certain advantages. Though not required to practice aspects of the disclosure, these advantages may include those provided by the following features.

Some embodiments enable a system and a method to add an additional verification layer which relies on a registry of known senders shared between participating mail service providers by using a distributed ledger technology.

Although implementations for methods and systems for authenticating a sender of the E-mail over the network have been described in language specific to structural features and/or methods, it is to be understood that the appended claims are not necessarily limited to the specific features or methods described. Rather, the specific features and methods are disclosed as examples of implementations for facilitating authentication of the sender.

1. A computer implemented method for authenticating a sender of an Electronic mail (E-mail) over a network, the computer implemented method comprising:
assigning, by a processor, a public key and a private key to each E-mail address of a plurality of E-mail addresses, wherein the public key and the private key are assigned upon registration of the E-mail address with an E-mail service provider of a plurality of E-mail service providers;
storing, by the processor, a plurality of public keys associated to the plurality of E-mail addresses over a blockchain associated to the plurality of E-mail service providers;
sending, by an E-mail service provider of a sender, an E-mail to a recipient over a network by creating a header in the E-mail storing content that needs to be sent to the recipient, wherein the content is signed by using a private key associated to the E-mail address belonging to the sender;
analyzing, by an E-mail service provider of the recipient, the header to determine whether the E-mail address is present over the blockchain;
retrieving, by the E-mail service provider of the recipient, a public key of the plurality of public keys, corresponding to the E-mail address from the blockchain, when the E-mail address is present on the blockchain; and
authenticating, by the processor, the sender of the E-mail upon verifying the signature, used to sign the content, by using the public key retrieved for the E-mail address from the blockchain.

2. The method as claimed in claim 1, wherein the E-mail is sent to the recipient over the network by using Simple Mail Transfer Protocol (SMTP).

3. The method as claimed in claim 1, wherein the E-mail is marked as verified when the sender of the E-mail is authenticated, and wherein the E-mail is marked as fraudulent when the sender of the E-mail is not authenticated.

4. A system for authenticating a sender of an Electronic mail (E-mail) over a network, the system comprising:
a processor; and
a memory coupled to the processor, wherein the processor is capable of executing a plurality of modules stored in the memory, and wherein the plurality of modules comprising:
a key assigning module for
assigning a public key and a private key to each E-mail address of a plurality of E-mail addresses, wherein the public key and the private key are assigned upon registration of the E-mail address with an E-mail service provider of a plurality of E-mail service providers, and
storing a plurality of public keys associated to the plurality of E-mail addresses over a blockchain associated to the plurality of E-mail service providers;
a sender's E-mail service provider module for sending an E-mail to a recipient over a network by creating a header in the E-mail wherein content that needs to be sent to the recipient is stored, wherein the content stored in the header is signed by using a private key associated to the E-mail address belonging to the sender, and
a recipient's E-mail service provider module for:
enabling an E-mail service provider of the recipient to analyze the header in order to determine whether the E-mail address is present over the blockchain, and
retrieving a public key, of the plurality of public keys, corresponding to the E-mail address from the blockchain, when the E-mail address is present on the blockchain; and
an authentication module for authenticating the sender of the E-mail upon verifying the signature, used to sign the content, by using the public key retrieved for the E-mail address from the blockchain.

5. The system as claimed in claim 4, wherein the sender's E-mail service provider module sent the E-mail to the recipient over the network by using Simple Mail Transfer Protocol (SMTP).

6. The system as claimed in claim 4, wherein the E-mail is marked as verified when the sender of the E-mail is authenticated, and wherein the E-mail is marked as fraudulent when the sender of the E-mail is not authenticated.

7. A non-transitory computer readable medium embodying a program executable in a computing device for authenticating a sender of an Electronic mail (E-mail) over a network, the program comprising a program code:
a program code for assigning a public key and a private key to each E-mail address of a plurality of E-mail addresses, wherein the public key and the private key are assigned upon registration of the E-mail address with an E-mail service provider of a plurality of E-mail service providers;
a program code for storing a plurality of public keys associated to the plurality of E-mail addresses over a blockchain associated to the plurality of E-mail service providers;
a program code for sending, by an E-mail service provider of a sender, an E-mail to a recipient over a network by creating a header in the E-mail, storing content that needs to be sent to the recipient wherein the content stored in the header is signed by using a private key associated to the E-mail address belonging to the sender;
a program code for analyzing, by an E-mail service provider of the recipient, the header to determine whether the E-mail address is present over the blockchain;
a program code for retrieving, by the E-mail service provider of the recipient, a public key of the plurality of public keys, corresponding to the E-mail address from the blockchain, when the E-mail address is present on the blockchain; and
a program code for authenticating the sender of the E-mail upon verifying the signature, used to sign the content, by using the public key retrieved for the E-mail address from the blockchain.
